(19) United States
(12) Patent Application Publication
(10) Pub. No.: US 2007/0083278 A1
(43) Pub. Date: Apr. 12, 2007

(54) METHOD AND APPARATUS FOR AUDIO SYNCHRONIZATION

(75) Inventor: Wai-Leong Poon, Richmond Hill (CA)

Correspondence Address: ADVANCED MICRO DEVICES, INC.;C/O VEDDER PRICE KAUFMAN & KAMMHOLZ, P.C., 222 N.LASALLE STREET, CHICAGO, IL, 60601, US

(73) Assignee: Advanced Micro Devices, Inc., Sunnyvale, CA (US)

(21) Appl. No.: 11/609,194

(22) Filed: Dec. 11, 2006

Related U.S. Application Data
(63) Continuation of application No. 10/406,433, filed on Apr. 3, 2003.

(51) Int. Cl. G06F 17/00

(52) U.S. Cl. 700/94

(57) ABSTRACT

A method and apparatus utilizing a single processor and a plurality of memories for providing audio synchronization including writing an incoming PES audio stream having header information, PTS timing information and payload information and audio information to an input buffer. The method and apparatus further includes reading the incoming audio stream from the input buffer and parsing the timing information and the audio information. The audio information, ES information, is written to an intermediate buffer. Based on the timing information, the method and apparatus further includes reading the audio information from the intermediate buffer and decoding the audio information to generate decoded audio information, PCM information. The method and apparatus includes writing the decoded audio information in an output buffer, wherein the decoded audio information may be provided from the output buffer to a digital-to-analog converter and thereupon provided to an audio system.

### RELATED APPLICATIONS

This application is a continuation of co-pending U.S. application Ser. No. 10/406,433, filed Apr. 3, 2003, entitled “Method and Apparatus for Audio Synchronization”, having as inventor Wai-Leong Poon, and owned by instant assignee and is incorporated herein by reference.

### FIELD OF THE INVENTION

The present invention relates generally to audio signal processing and more specifically to audio signal synchronization.

### BACKGROUND OF THE INVENTION

In a typical media processing system, an audio portion and a video portion of a media signal are encoded independently. Thereupon, the audio and video portions may be separately processed and based on timing information, provided to corresponding output displays in synchronization. For example, the video portion of the incoming media signal may be provided to a display screen and the audio portion of the incoming media signal may be provided to a speaker or other audio output system,

In one embodiment, the audio portion of the incoming media signal may be encoded in a packetized elementary stream (“PES”). FIG. 1 illustrates a prior art audio processing system 160 for decoding a PES input 102. As recognized by one having skill in the art, the PES input 102 includes multiple packets of data.

FIGS. 2 and 3 illustrates representative examples of PES input 200 and 300. The PES input 200 of FIG. 2 includes header information 202 and payload information 204 as the PES input 300 of FIG. 3 also includes header information 302 and payload information 304. The payload 204 of FIG. 2 conveniently store three complete frames 206, 208 and 210 of audio data, whereas the payload 304a stores two full frames 306 and 308 and part of a third frame 310a. The other part of the frame 310b is stored in the second payload 304b along with two full frames 312 and 314. Therefore, the audio processing system 100 of FIG. 1 must be capable of processing the PES input 102 having partial or whole frames of audio information per payload.

Furthermore, the headers 202 and 302 typically contain error detection information, such as CRC. The header 202 and 302 further typically contains timing information referred to as presentation time stamp (“PTS”). The PTS is utilized during the processing of the payload information 204, 304 to provide for the proper synchronization of the output of the content (such as 206, 208 and 210 of FIG. 2), as the PTS may be compared with a local time provided by a System Time Counter (“STC”) clock.

Continuing with FIG. 1, a PES parser 104 receives the PES input 102 and thereupon decodes the PES input in accordance with known PES decoding techniques, such as those found in the Xilleon family of processors available from ATI Technologies, Inc. The PES parser 104, when requested by 108, generates an elementary stream (“ES”) input 106 that is provided to an ES decoder 108. In one embodiment, the ES input 106 includes the payload information (such as 204 of FIG. 2 or 304 of FIG. 3) without the header information (such as 202 of FIG. 2 or 302 of FIG. 3). The ES decoder 108 thereupon processes the ES input 106 in accordance with known ES decoding techniques, such as those found in the Xilleon family of processors available from ATI Technologies, Inc.

The ES decoder 108 thereupon generates a pulse code modulated (“PCM”) audio stream 110 that is provided to an audio interface 112. The audio interface 112 converts the PCM audio stream 110 into a digital audio signal 114 in accordance with known audio interface technology, such as those found in the Xilleon family of processors available from ATI Technologies, Inc. The digital audio signal 114 is provided to a digital-to-analog converter (“DAC”) 116. The DAC 116 thereupon generates an audible analog signal that may be provided to an output device, such as an audio speaker.

A recent trend in modern computing systems is the reduction in size of processing systems and the reduction of the number of components to reduce overall production costs. The prior art system 100 of FIG. 1 is a system having at least three separate digital signal processors, the PES parser 104, the ES decoder 108 and the audio interface 112. It would be advantageous to present a processing system having a reduced number of processors, thereby reducing not only production costs but also reducing the size of the processing system.

By eliminating separate processors for the PES parser 104 and the ES decoder 108, problems arise regarding the parsing of the payload, ES input 106, from the input signal 102. Utilizing a common processor to execute the operations of the PES parser 104 and the ES decoder is problematic because the PES parser 104 does not pre-parse PES packets and the ES decoder 108 must request the PES parser 104 to execute every time the ES decoder 108 needs the ES input 106. In a digital signal processing system, this is extremely inefficient as it requires extra processing instructions and thereupon decreases the efficiency of the digital signal processing MIPS utilization, due to having to load the PES parser 104 executable instructions to have the digital signal processor parse more payload for the ES decoder 108.

Furthermore, in the event the PES parser 104 receives the PES input 300 of FIG. 3, the digital signal processor may be required to reload the PES parser executable instructions multiple times just to complete a single frame for the ES decoder 108. Moreover, since the PES parser and the ES decoder are executed at a different time, the ES decoder 108 cannot utilize any high level timing information provided in the PES input 102, more specifically within the header information, such as 202 of FIG. 2 because the delay between PES parsing and ES decoding is uncertain. As such, the PES parser 104 is limited in determining wherein the ES decoder 108 is within a decoding processing, which directly affects the synchronization of the audio processing system.

Therefore, there exists a need for a method and apparatus for synchronizing audio output based on the STC clock both when the payload contains an integer number of frames and when the payload contains a non-integer number of frames of audio data and the system using a reduced number of processors.

### BRIEF DESCRIPTION OF THE DRAWINGS

FIG. 1 illustrates a schematic block diagram of a prior art apparatus for audio synchronization;

FIG. 2 illustrates an input PES audio stream;

FIG. 3 illustrates an alternative embodiment of an incoming PES audio stream;

FIG. 4 illustrates an apparatus for audio synchronization in accordance with one embodiment of the present invention;

FIG. 5 illustrates another representation of the apparatus for audio synchronization, in accordance with one embodiment of the present invention;

FIG. 6 illustrates a flow chart of a method for audio synchronization in accordance with one embodiment of the present invention;

FIG. 7 illustrates a flow chart of a method for audio synchronization in accordance with an alternative embodiment of the present invention;

FIG. 8 illustrates a flow chart of a method for audio synchronization in accordance with an alternative embodiment of the present invention;

FIG. 9 illustrates a schematic block diagram of the parsing of an input stream in accordance of one embodiment of the present invention;

FIG. 10 illustrates a schematic block diagram of an alternative representation of the apparatus for audio synchronization, in accordance with one embodiment of the present invention; and

FIG. 11 illustrates a flow chart of a method for audio synchronization in accordance with one embodiment of the present invention.

### DETAILED DESCRIPTION OF A PREFERRED EMBODIMENT

Generally, a method and apparatus for audio synchronization includes writing an incoming audio stream having timing information and audio information to an input buffer. A typical incoming audio stream is a PES stream representing audio information with regards to a multi-media signal. The incoming audio stream includes header information having error detection code, PTS timing information and a plurality of payloads containing encoded audio information.

The method and apparatus further includes reading the incoming audio stream from the input buffer and parsing the timing information and the audio information from the incoming audio stream. The audio information is written to an intermediate buffer and, in one embodiment, the timing information is written to a timing information buffer.

Based on the timing information, the method and apparatus further includes reading the audio information from the intermediate buffer and decoding the audio information to generate decoded audio information. In one embodiment, if the incoming audio stream is a PES stream, the audio information is an ES stream, furthermore the decoded audio information represents a PCM data stream. Thereupon, the method and apparatus includes writing the decoded audio information in an output buffer, wherein the decoded audio information may be provided from the output buffer to a digital-to-analog converter and thereupon provided to an audio system, such as a speaker, amplifier, pre-amplifier, or any other suitable audible producing system as one recognized by one having ordinary skills in the art. The input buffer, intermediate buffer and output buffer may be, but not limited to, a single memory, a plurality of memory locations, shared memory, CD, DVD, RAM, EEPROM, optical storage, microcode or any other non-volume storage capable of storing digital data.

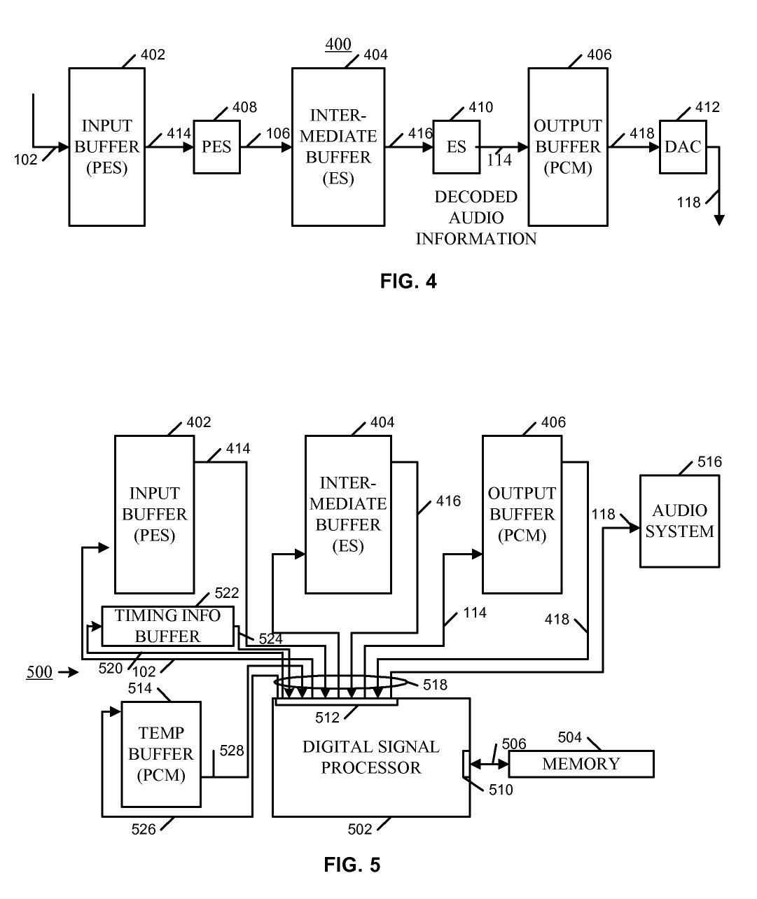

FIG. 4 illustrates an apparatus 400 for audio synchronization, the apparatus including an input buffer 402, an intermediate buffer 404, an output buffer 406, a PES processing module 408, an ES processing module 410 and a digital-to-analog converter module 412. FIG. 4 generally represents the PES module 408, the ES module 410 and the DAC module 412 as separate and distinct modules, but as described below with respect to FIG. 5, these modules are all executable programming instructions executed on a common digital signal processor, but have been illustrated as separate modules in FIG. 4 for clarification purposes only.

In accordance with one embodiment of the present invention, the input buffer (PES) 402 receives the incoming audio stream 102, wherein the incoming audio stream, as discussed above, includes timing information in the header 202 and audio information within the payload 204 as represented with respect to audio stream 200 of FIG. 2. In one embodiment, the incoming audio stream, otherwise referred to as the PES stream, is written in a first in first out (“FIFO”) manner within the buffer 402. The PES module 408 thereupon reads a portion 414 of the incoming audio stream and parses the timing information from the audio information within the stream 414. Thereupon, the PES module 408 writes the audio information to the intermediate buffer 404, also in one embodiment in a FIFO manner.

The ES module 410 reads a portion 416 of the ES stream, the audio information, from the intermediate buffer 404 and decodes the audio information to generate decoded audio information 114. In the preferred embodiment, as the ES module 410 represents a processing device executing operational instructions, the ES module 410 further includes audio interface processing as discussed above with regards to the audio interface 112 of the prior art system. Therefore, the decoded audio information 114 may be provided to the output buffer (PCM) 406. In one embodiment, the decoded audio information is within a PCM format and is stored within the output buffer 406 in a FIFO manner. The digital-to-analog converter module 412 may thereupon read a portion 418 of the decoded audio information 114 stored within the output buffer 406 and generate the output signal 118.

In the preferred embodiment, the timing information, upon being parsed from the portion of the PES stream 414 is provided to a timing information buffer (not illustrated). The apparatus 400 is disposed within a processing system having an internal or local clock timing information, such as a system time counter (STC) clock. The PTS information disposed within the header for each portion 414 of the input audio stream is compared with the local clock timing information. Based on this comparison, the apparatus 400 synchronizes the parsing of the PES stream to provide an adequate amount of audio information 106 within the intermediate buffer 404 such that the ES module 410 and the DAC module 412 may effectively generate the audio output signal 118 without needing to monitor timing synchronization.

FIG. 5 illustrates an alternative representation of an apparatus for audio synchronization 500 including a digital signal processor 502, a memory 504, wherein the memory 504 stores executable instructions 506 which may be provided to the digital signal processor 502. The digital signal processor 502 may be, but not limited to, a signal processor, a plurality of processors, a DSP, a microprocessor, ASIC, state machine, or any other implementation capable of processing and executing software. The term processor should not be construed to refer exclusively to hardware capable of executing software, and may implicitly include DSP hardware, ROM for storing software, RAM and any other volatile or non-volatile storage medium. The memory 504 may be, but not limited to, a single memory, a plurality of memory locations, shared memory, CD, DVD, ROM, RAM, EEPROM, optical storage, microcode, or any other non-volatile storage capable of storing executable instructions 506 for use by the digital signal processor 502.

The digital signal processor 502 includes a first input port 510 capable of receiving the executable instructions 506 from the memory 504 and a second input port 512 operably coupled to the input buffer 402, the intermediate buffer 404, the output buffer 406, a temporary buffer 514, an audio DAC 516 and an audio system 517. As recognized by one having ordinary skill in the art, the digital signal processor 502 may be operably coupled to each of these individual devices through the second input port 512 or the second input port 512 may be operably coupled to one or more busses, collectively designated at 518, for providing communication thereacross.

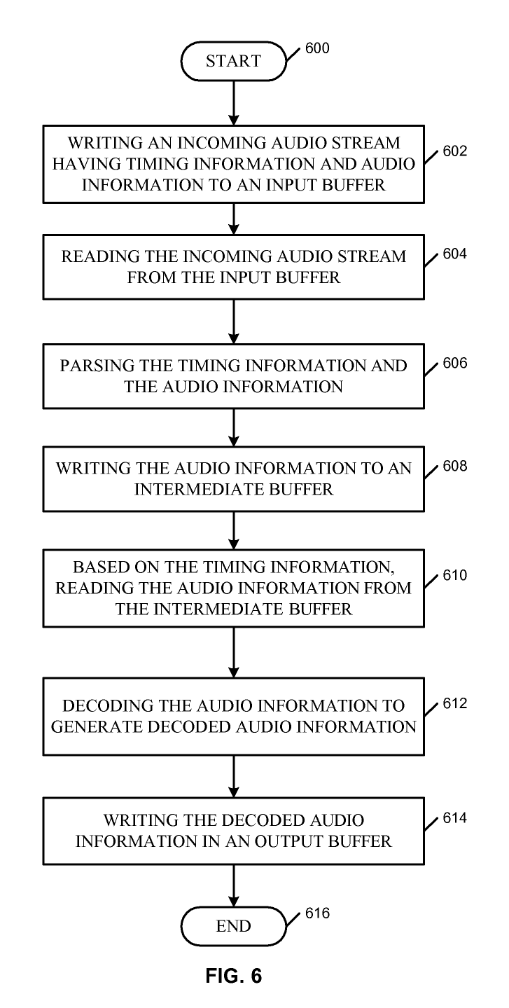

The digital signal processor 502, in response to executable instructions 506 from the memory 504 performs steps in different embodiments as discussed below with regards to FIGS. 6-8. Therefore, the operation of the apparatus 500 and the digital signal processor 502 will be discussed with respect to FIGS. 6-8.

FIG. 6 illustrates a flow chart of the method for audio synchronization in accordance with one embodiment of the present invention. The method begins, 600, by writing the incoming audio stream 102 having timing information (such as found within the header 202 of the incoming stream 200 of FIG. 2) and audio information (such as found within the payload 204 of the input stream 200 of FIG. 2) to the input buffer 402, step 602. In one embodiment, the digital signal processor 502 may receive a multi-media signal (not illustrated) and thereupon provide the audio stream 102 across the output port 512 via bus 518 to the input buffer 402 and provide other aspects of the multi-media signal to other elements as recognized by one having ordinary skill in the art.

In the next step, step 604, reading the incoming audio stream 414 from the input buffer 402. In one embodiment, the input buffer 402 is a FIFO buffer, thereupon the incoming audio stream 414 is read in a first in first out manner from the input buffer 402. Thereupon, the digital signal processor 502 parses the timing information and the audio information, step 606. As discussed above with regards to FIG. 4, the digital signal processor 502 operates as the PES module 408 of FIG. 4.

The method further includes writing the audio information 106 to the intermediate buffer 404, step 608. Based on the timing information, as discussed below, the digital signal processor 502 reads the audio information from the intermediate buffer, step 610. The next step, 612, includes the digital signal processor 502 in response to the executable instructions 506, decoding the audio information 416 to generate decoded audio information 114. The digital signal processor 502 acts in accordance with the operations of the ES module 410 of FIG. 4. Thereupon, the digital signal processor 502 further writes the decoded audio information 114 in the output buffer 406, step 614. As such, the method of this embodiment is complete, step 616.

In this embodiment, the incoming audio stream 102 is parsed by the digital signal processor 502 performing operations of the PES parser 408 and further decoding and performing audio interface functions on the ES stream when the digital signal processor 502 acts as the ES decoder 410 of FIG. 4, thereby producing a PCM output signal. In this embodiment, the digital signal processor 502 operates as both the PES parser 408 and the ES decoder 410 by performing executable instructions 506, thereby reducing the number of signal processors within the processing system and efficiently utilizing the plurality of buffers for the management of audio data.

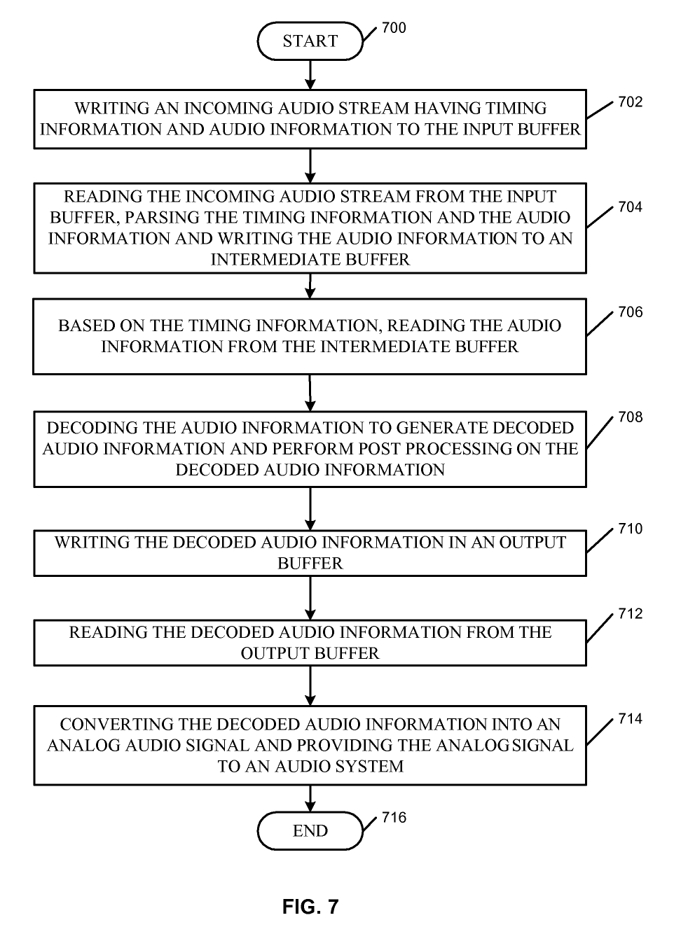

FIG. 7 illustrates an alternative embodiment of a method for audio synchronization, as described below with regards to FIG. 5. The method begins, step 700, by writing the incoming audio stream 102 having timing information and audio information to the input buffer, step 702. Thereupon, the digital signal processor 502 reads the incoming audio stream from the input buffer, parses the timing information therefrom and writes the audio information to the intermediate buffer 404, step 704. Furthermore, based on the timing information, the digital signal processor 502 reads the audio information from the intermediate buffer, step 706. Similar to step 610 the embodiment illustrated in FIG. 6, the timing information is compared with the local system time counter clock to provide for synchronization.

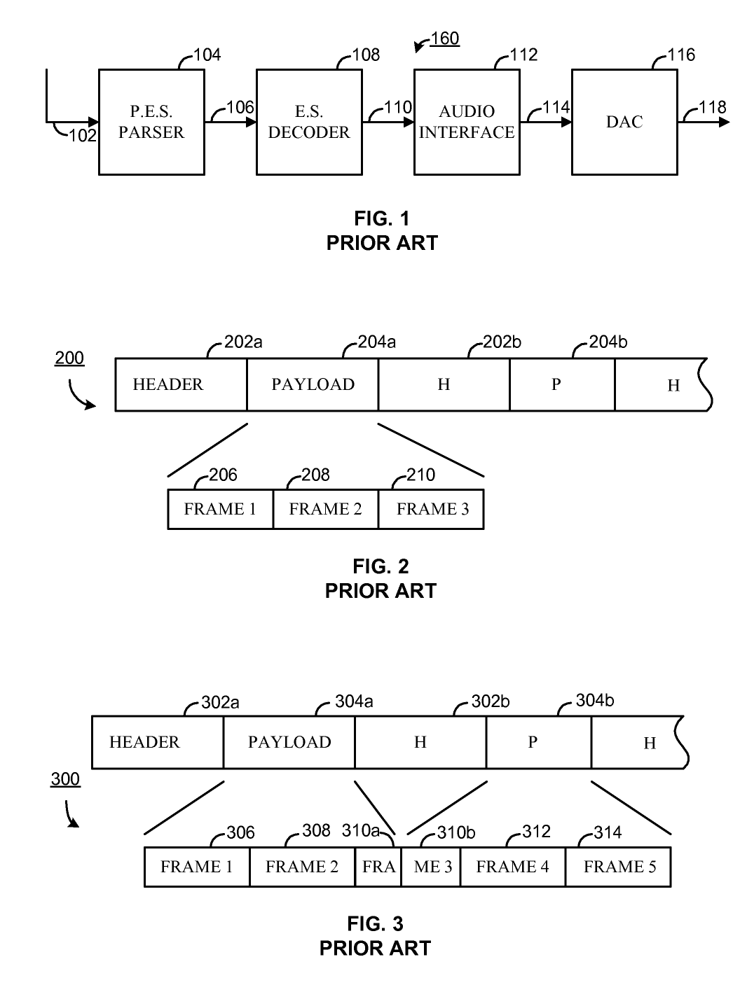

The next step, step 708, includes decoding the audio information to generate decoded audio information and perform post processing of the decoded audio information, step 708. In one embodiment, the post processing performed on the decoded audio information may be performed by the digital signal processor 502 and includes operations similar to those performed by the audio interface 112 as discussed above with regards to prior art FIG. 1, such as sample rate conversion, volume control and audio mixing.

The decoded audio information is thereupon written in the output buffer 406 by the digital signal processor 502, step 710. The digital signal processor then reads the decoded audio information from the output buffer, step 712 and have it fed into the digital-to-analog converter 512 of FIG. 4 for digital to analog conversion. The digital-to-analog converter provides the analog signal 118 to the audio system 517. As such, the method of FIG. 7 is complete, step 716. Similar to the method of FIG. 6, the method of FIG. 7 provides for efficient utilization of an audio processing system by providing for the synchronization of audio output 118 in accordance with the STC clock using a single digital signal processor 502 operating multiple executable instructions 506 from the memory 504 and the plurality of buffers, 402, 404 and 406.

Furthermore, the digital signal processor 502 operates in efficient manner by utilizing the synchronization of the parsed audio information from the input stream being provided to the intermediate buffer 404 such that the digital signal processor 502 saves processing cycles by efficiently executing ES decoder operations and PES parser 408 operations without having to reload executable instructions for each of the different processors. Stated alternatively, the digital signal processor 502 when executing instructions in accordance with the PES parser 408 writes enough ES data to the intermediate buffer 404 such that the digital signal processor 502 when acting as the ES decoder 410 may not have to calculate synchronization information and further may efficiently and effectively rely on information within the intermediate buffer 404 as being properly synchronized.

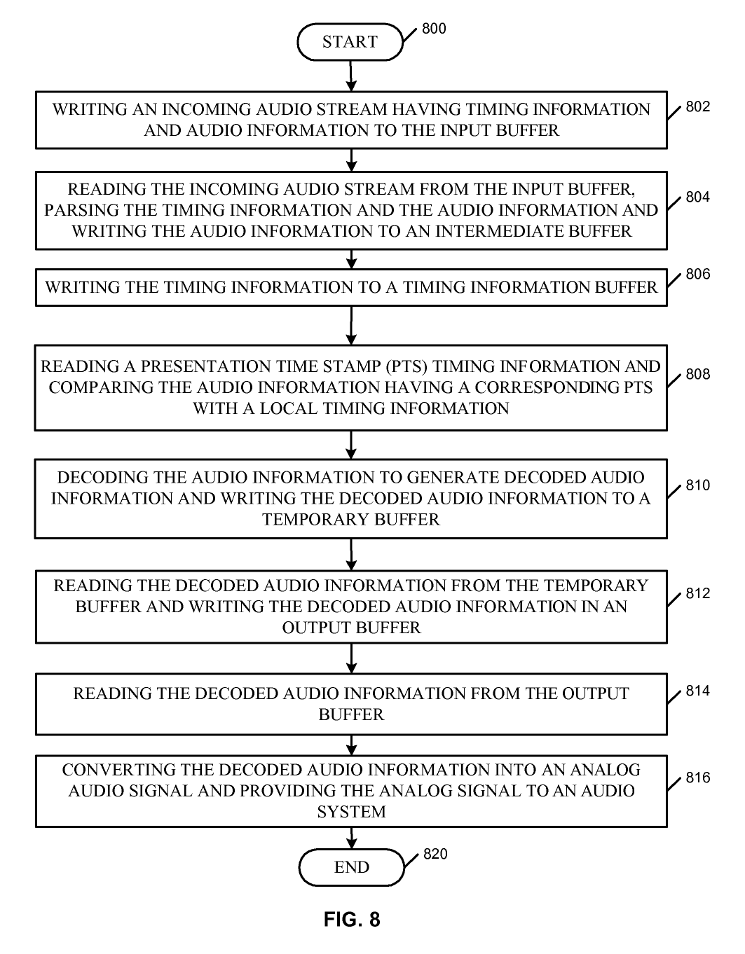

FIG. 8 illustrates another embodiment of a method for audio synchronization, the method begins step 800 by writing the incoming audio stream having timing information and audio information to the input buffer 402, step 802. The next step is reading the incoming audio stream from the input buffer, parsing the timing information and the audio information and writing the audio information to an intermediate buffer, step 804. Similar to the embodiments discussed above with regards to FIGS. 6 and 7, the digital signal processor 502 of FIG. 5 performs the steps.

The next step, step 806, is writing the timing information 520 to the timing information buffer 522 which may be any suitable storage capable of storing timing information. In one embodiment, the timing information 520 is PTS timing information extracted from a header (such as header 202 of FIG. 2). Thereupon, the PTS timing information 524 is read from the timing information buffer 522 and compared with local timing information, step 808. Based on this timing information being synchronized with the local timing information, the audio information is decoded to generate decoded audio information and the decoded audio information is written to the temporary buffer 514. In one embodiment, the decoded audio information 526 is temporarily stored in the temporary buffer 514, stored therein as PCM data. The next step, step 812 is reading the decoded audio information 528 from the temporary buffer 514 and writing the decoded audio information 114 in the output buffer 406. Once again, the digital signal processor 502 processes the decoded audio information 528, 114 across the representative bus 518 via the second input port 512, in response to the executable instructions 506 provided from the memory 504.

The digital signal processor 502 thereupon reads the decoded audio information 418 from the output buffer 406, step 814 and converts the decoded audio information into the analog audio signal 118 using a DAC, step 816. Thereupon, the method is complete, step 820.

The above discussion describes the present invention in terms of the sequential ordering of the processing of audio information to provide for synchronized output. More specifically, the below discussion provides the specific process for insuring audio synchronization through the digital signal processor 502 of FIG. 5 acting as the PES parser 408 of FIG. 4 such that all further signal processing performed by the digital signal processor 502 may be properly executed in reliance upon effective and proper timing synchronization.

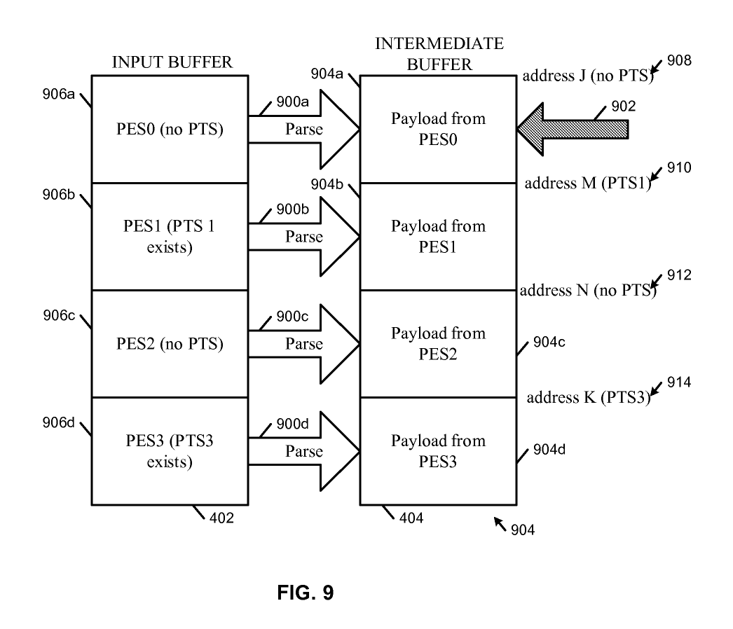

FIG. 9 illustrates the input buffer 402 and the intermediate buffer 404 and the execution of the parsing step 900 based on PES packets and a designation of whether a PTS is included therein. In one embodiment, the intermediate buffer 404 includes a read pointer 902 which indicates the reading address location from which the payload information 904 is stored therein. In normal operations, the PES parser, such as the PES module 408, operating instructions executable instructions 506 by the digital signal processor 502 receives PES packets 906, which as recognized by one having ordinary skill in the art, are included within the incoming audio stream 102. Based on a first parsing operation 900A, the PES packet 906A not having a PTS therein is written to the intermediate buffer as the payload from PES 906A, designated as 904A. The PES parser thereupon parses 900B the second PES packet 906B having a PTS therein and writes the payload from PES 1 into intermediate buffer storage location 904B. The PES parser records the relationship between the start address of each payload and the PTS in a PTS array, wherein the PES parser further records the PTS timing information into the timing information buffer, such as 522 of FIG. 5.

Continuing with the operation of the PES parser, the third PES packet 906C which does not have a PTS timing information stored therein is parsed 900C and the payload from the PES 2 is written to intermediate buffer storage location 904C. Furthermore, the fourth PES data packet 906D which has a PTS timing information stored therein is parsed 900D and the payload is written to the intermediate buffer 904D. Furthermore, as the PES parser records the relationship between the start address of each payload and a PTS, if it exists within the PES payload, FIG. 9 further illustrates address designations for the intermediate buffer with address J 908 and an indication that no PTS timing information exists, address M 910 having PTS information therein, address N 912 not having any PTS information therein and address K 914 having PTS information therein. The PES parser decides if the audio PTS and the STC are in sync whenever the read pointer of the intermediate FIFO crosses a payload boundary, wherein the payload boundary would be representative of crossing from address J to address M as address M indicates a payload boundary from the first PES packet 906A and the second PES packet 906B and the payload from the second PES packet 904B. In case the read pointer 902 crosses the payload boundary without a PTS, no synchronization action is therefore required.

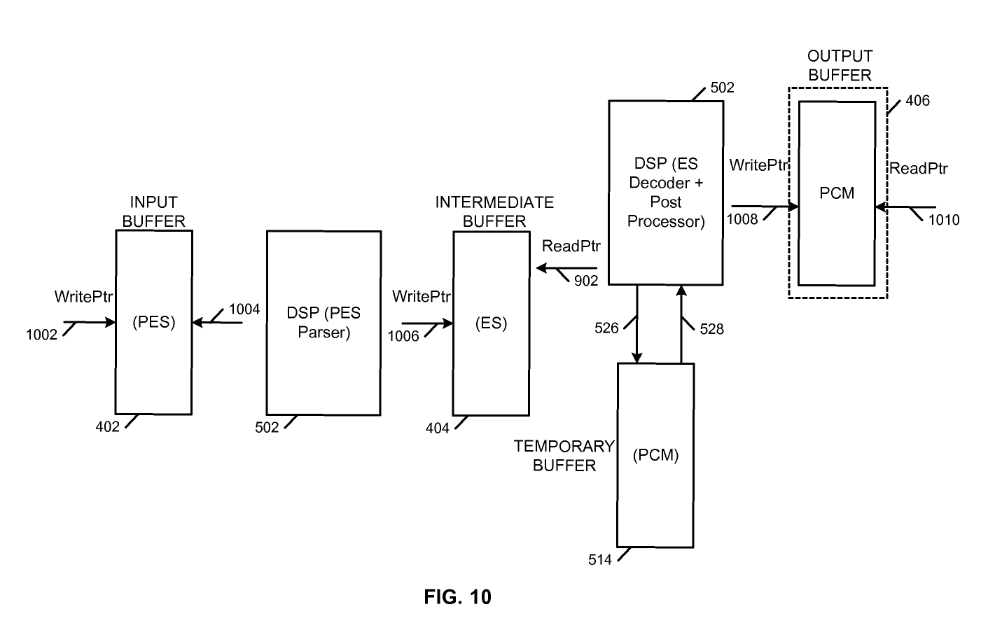

FIG. 10 illustrates the decoder processing stages having the digital signal processor 502 individually referenced when executing specific executable instructions, such as 506 from the memory 504, similar to the illustrations of FIG. 4. The stages further include the multiple buffers 402, 404, 406 and 514. FIG. 10 illustrates the present invention from the perspective of pointers utilized for controlling and managing the synchronization of the audio data. A write pointer 1002 is utilized to indicate where the next packet of PES data within the incoming audio stream is to be written in the input buffer 402. The system 1000 also includes a read pointer 1004 to indicate where the digital signal processor 502 operating as the PES parser should effectively read incoming packets of PES data, similar to the packets 906 of FIG. 9.

As discussed above, the DSP acting as a PES parser 502 thereupon parses the timing information from the payload information and a write pointer 1006 is utilized to indicate where the next packet of payload information is to be written within the intermediate buffer 404. The system 1000 further includes the read pointer 902, as discussed above with regards to FIG. 9 which provides for indicating where payload information is read from the intermediate buffer and provided to the digital signal processor 502 herein performing executable instructions to operate as the ES decoder and post processor. In one embodiment, the digital signal processor 502 may thereupon write PCM output data 526 to the temporary buffer 514 which may thereupon be provided back to the digital signal processor 502 as output data 528.

The system 1000 further includes a write pointer 1008, which may be utilized by the digital signal processor 502 to thereupon write the decoded audio information to the output buffer 406. The system further includes a read pointer 1010, which allows for the reading of the decoded audio data which is in PCM format from the output buffer 406 which may thereupon be converted into an analog signal from its digital format by a DAC.

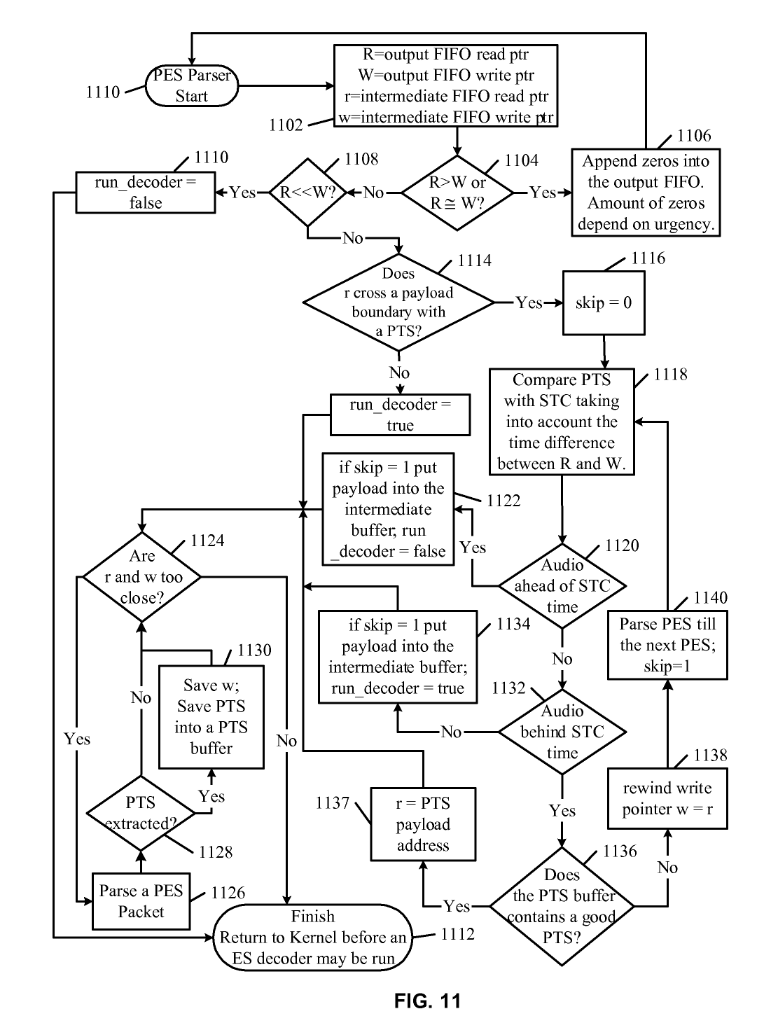

FIG. 11 illustrates a flowchart representing the steps for audio synchronization in accordance with one embodiment of the present invention. The method begins, step 1100, when the PES parser receives an incoming audio stream, when the PES parser is the digital signal processor 502 operating in response to executable instructions 506 from the memory 504. The next step, step 1102 is registering pointer values such that R equals the output buffer read pointer, W equals the output buffer write pointer, r equals intermediate buffer read pointer and w equals intermediate FIFO write pointer.

The next step is determining whether or not the output buffer read pointer is greater than the output FIFO write pointer or the output buffer read pointer is approximately equal to the output buffer write pointer, Step 1104. If this is true, the next step is to append zeros into the output buffer whereupon the number of zeros added into the output buffer depends upon the urgency, which provides for muting an output audio signal provided to the DAC, step 1106. In the event step 1104 is false, another determination is whether or not the output FIFO read pointer is much less than the output FIFO write pointer, step 1108. If step 1108 is true, it sets the variable “run_decoder” to false, step 1110, and the method is complete, step 1112, such that the digital signal processor may execute another operation before operating ES decoder executable instructions. If run_decoder is true, the ES decoder is executed after the PES parser exits. If run_decoder is false, the ES decoder is not executed after the PES parser exits.

In the event step 1108 is false (no), it is determined whether or not the intermediate buffer read pointer crosses a payload boundary having a PTS, step 1114. If the answer is affirmative (yes), an initial skip value may be set equivalent to zero, step 1116 and a comparison of the PTS with an STC value is performed, taking into account the time difference between the output buffer read pointer and the output buffer write pointer, step 1118. Another determination is made as to whether the audio is leading STC, step 1120. If the answer is affirmative, and the skip value is equal to 1, the PES payload is placed into the intermediate buffer and the run_decoder value is set to false, step 1122. Thereupon, the determination is made as to whether the intermediate buffer read pointer and the intermediate buffer write pointer are close values, step 1124. If it is determined that these values are close, the next step is to parse a PES packet, step 1126 and if r and w are not close, the method is completed, step 1112.

After the execution of step 1126 and parsing a PES packet, a determination is made whether a PTS has been extracted, step 1128. If a PTS has been extracted, the intermediate buffer write pointer is saved and the PTS is written into a PTS buffer, step 1130. If no PTS has been extracted step 1130 is not executed. Regardless thereof, step 1124 is re-executed.

Returning to step 1120, which is the determination of whether the audio is ahead of the STC time, in the event that the audio is not ahead of the STC time, another determination, step 1132, is whether the audio is behind the STC time. If the audio is not behind the STC time and the skip value is equivalent to 1, the next step is to place the payload into the intermediate buffer and set the run_decoder value to true, step 1134. Thereupon, the next step is, step 1124, to determine if the intermediate buffer read pointer is close to the intermediate buffer write pointer.

Referring back to step 1132, if the audio is behind the STC time, the next step is determining if the PTS buffer contains a good PTS, step 1136. If the buffer does not contain a good PTS, the next step is to rewind the write pointer such that the intermediate buffer read pointer is equal to the intermediate buffer write pointer, step 1137. The next step 1140 is to parse the PES packets until the next PTS and set the skip value equivalent to 1. Thereupon, once again step 1118 is reexecuted by comparing the PTS with the STC, taking into account the time difference between the output buffer read pointer and the output buffer write pointer.

In the event that the PTS buffer contains a good PTS, step 1136, the next step is setting the intermediate buffer read pointer equivalent to the PTS payload address, step 1138. Thereupon, the next step is step 1124, once again determining if the intermediate buffer read pointer is close to the intermediate buffer write pointer.

By following the steps above, which are executed through operations of the digital signal processor acting as a PES parser and ES decoder, a processing system can utilize a single digital signal processor to function in the manner similar to previous systems having multiple signal processors dedicated to each of the various elements. Moreover, the present invention provides for the PES parser to always execute operations before the ES decoder such that all synchronization is confirmed prior to the operation of the digital signal processor acting as the ES decoder. Furthermore, the PES parser ensures adequate audio information within the intermediate buffer such that the ES decoder may properly and effectively execute without having to stop execution and reprogram the digital signal processor to operate as a PES parser to provide more PES packets for the ES decoder. As such, the present invention improves over prior art computation techniques by utilizing a reduced number of processing elements and further efficiently utilizing processor cycles.

It should be understood that there exist implementations of other variations and modifications of the invention and its various aspects, as may be readily apparent to those of ordinary skill in the art, and that the invention is not limited by the specific embodiments described herein. For example, the executable instructions may be stored in a multiple memory locations (illustrated as 504 of FIG. 5) and/or the multiple buffers 402, 404 and 406 may be designated portions of a single buffer system or may be disposed across multiple memory modules, such as a multiple buffers for each of the specific buffers 402, 404 and 406. It is therefore contemplated to cover, by the present invention, any and all modifications, variations, or equivalents to fall within the spirit and scope of the basic underlying principles disclosed and claimed herein.

What is claimed is:

1. A digital signal processor comprising:
a first output port coupled an external memory;
a second output port coupled to a plurality of buffers, including an input buffer, an intermediate buffer, a temporary buffer and an output buffer; and
the digital signal processor, in response to executable instructions from the external memory:
writes an incoming audio stream having timing information and audio information to the input buffer;
reads the incoming audio stream from the input buffer;
parses the timing information and the audio information;
writes the audio information to the intermediate buffer;
based on the timing information, reads the audio information from the intermediate buffer;
decodes the audio information to generate decoded audio information;
writes the decoded audio information in the temporary buffer;
reads the decoded audio information from the temporary buffer;
performs post processing on the decoded audio information to generate post processed decoded audio information; and
stores the post processed audio information in an output buffer.

2. The digital signal processor of claim 1, wherein the digital signal processor, in response to executable instructions:
reads the post processed audio information from the output buffer;
sends the post processed audio information to a digital to analog converter that provides the analog audio signal to an audio system.

3. The digital signal processor of claim 1 wherein the incoming audio stream is a packetized elementary stream and the audio information is an elementary stream.

4. The digital signal processor of claim 1, wherein the digital signal processor, in response to executable instructions:
writes the timing information to a timing information buffer;
after reading the audio information from the intermediate buffer, compares a presentation time stamp within the timing information with a local timing information; and
reads the audio information having a corresponding presentation time stamp equivalent to the local timing information.

5. The digital signal processor of claim 1, in response to executable instructions from the external memory;
maintains payload boundary information for a plurality of audio stream packet payloads stored in an intermediate buffer, wherein the payload boundary information includes address destination information for each of the plurality of audio stream packet payloads; and
determines if a current audio stream packet payload is synchronized when an intermediate buffer read pointer crosses a payload boundary where the current audio stream packet payload is associated with timing information from a current audio stream packet header.

6. A method for audio synchronization comprising:
maintaining payload boundary information for a plurality of audio stream packet payloads stored in an intermediate buffer, wherein the payload boundary information includes address destination information for each of the plurality of audio stream packet payloads; and
determining if a current audio stream packet payload is synchronized when an intermediate buffer read pointer crosses a payload boundary where the current audio stream packet payload is associated with timing information from a current audio stream packet header.

7. The method of claim 6, wherein the payload boundary information further includes information representing whether each of the audio stream packet payloads is associated with timing information.

8. The method of claim 6, wherein determining if the audio stream packet payload is synchronized comprises comparing timing information for the current audio stream packet payload with a system time clock.

9. The method of claim 6, wherein the address destination information represents a start location in the intermediate buffer for each of the plurality of audio stream packet payloads.

10. The method of claim 6, wherein an intermediate buffer read pointer crosses a payload boundary when the intermediate buffer read pointer was previously associated with a first audio stream packet payload and is currently associated with a second audio stream packet payload.

11. An apparatus comprising a digital signal processor and at least one memory containing instructions that when executed by the digital signal processor cause the digital signal processor to:
maintain payload boundary information for a plurality of audio stream packet payloads stored in an intermediate buffer, wherein the payload boundary information includes address destination information for each of the plurality of audio stream packet payloads; and
determine if a current audio stream packet payload is synchronized when an intermediate buffer read pointer crosses a payload boundary where the current audio stream packet payload is associated with timing information from a current audio stream packet header.

12. The apparatus of claim 11, wherein the payload boundary information further includes information representing whether each of the audio stream packet payloads is associated with timing information.

13. The apparatus of claim 11, wherein determining if the audio stream packet payload is synchronized comprises comparing timing information for the current audio stream packet payload with a system time clock.

14. The apparatus of claim 11, wherein the address destination information represents a start location in the intermediate buffer for each of the plurality of audio stream packet payloads.

15. The apparatus of claim 11, wherein an intermediate buffer read pointer crosses a payload boundary when the intermediate buffer read pointer was previously associated with a first audio stream packet payload and is currently associated with a second audio stream packet payload.

16. A method comprising:
determining whether a current intermediate buffer read pointer value was advanced across a payload boundary having timing information to provide a determination result, wherein each payload boundary represents a location in an intermediate buffer representing at least one of: a last part of a first previously stored audio stream packet payload and a first part of a second previously stored audio stream packet payload;
when the determination result is not favorable:
decoding at least a portion of the second previously stored audio stream packet payload; and
parsing an audio stream packet;
and
when the determination result is favorable:
decoding one of: at least the portion of the second previously stored audio stream packet payload, and at least a portion of one of a plurality of third previously stored audio stream packet payloads; and
parsing the audio stream packet.

17. The method of claim 16, wherein parsing the audio stream packet further comprises storing at least the portion of the audio stream packet payload in the intermediate buffer.

18. The method of claim 16, wherein parsing the audio stream packet further comprises storing timing information associated with the audio stream packet if the timing information was contained within a header of the audio stream packet.

19. The method of claim 16, wherein storing at least the portion of the audio stream packet payload in the intermediate buffer comprises storing at least the portion of the audio stream packet payload in the intermediate buffer at a location indicated by a current intermediate buffer write pointer value.

20. The method of claim 16, wherein when the determination result is favorable:
decoding at least the portion of the second previously stored audio stream packet payload if at least the portion of the second previously stored audio stream packet payload is determined to be on time with respect to a system time clock based on the timing information; and
decoding at least the portion of the one of the plurality of previously stored audio stream packet payloads if at least the portion of the second previously stored audio stream packet payload is determined to be behind time with respect to the system time clock based on the timing information and if at least the portion of the one of the plurality of previously stored audio stream packet payloads is determined to be one of: on time with respect to the system time clock based on timing information associated with the one of the plurality of previously stored audio stream packet payloads and ahead of time with respect to the system time clock based on timing information associated with the one of the plurality of previously stored audio stream packet payload.

21. The method of claim 20, wherein decoding at least the portion of the one of the plurality of previously stored audio stream packet payloads, the method further comprises setting the intermediate buffer read pointer value to a stored address associated with at least the portion of the one of the plurality of the previously stored audio stream packet payloads.

22. The method of claim 16, wherein when the determination result is favorable, parsing the audio stream packet if at least the portion of the second previously stored audio stream packet payload is determined to be behind time with respect to the system time clock based on the timing information and if at least the portion of the one of the plurality of previously stored audio stream packet payloads is determined to be behind time with respect to the system time clock based on timing information associated with the one of the plurality of previously stored audio stream packet payloads and if a header of the audio stream packet contains timing information.

23. The method of claim 16, wherein the timing information is a presentation time stamp.

24. The method of claim 16, wherein the current audio stream packet is a packet of a packetized elementary stream.

25. A method for audio synchronization comprising:
determining that at least a portion of a first previously stored audio stream packet payload is behind time with respect to a system time clock;
determining if at least a portion of one of a plurality of previously stored audio stream packet payloads is one of on time with respect to a system time clock and ahead of time with respect to a system time clock and producing a determination result;
if the determination result is favorable, decoding at least the portion of the one of the plurality of previously stored audio stream packet payloads; and
if the determination result is not favorable, parsing an audio stream packet and storing at least a portion of an audio stream packet payload in an intermediate buffer.

26. The method of claim 25, wherein:
at least the portion of the first previously stored audio stream packet payload is determined to be behind time with respect to the system time clock based on timing information associated with the first previously stored audio stream packet payload; and
at least the portion of the one of the plurality of previously stored audio stream packet payloads is determined to be one of on time with respect to the system time clock and ahead of time with respect to the system time clock based on timing information associated with the one of the plurality of previously stored audio stream packet payloads.

27. The method of claim 25, wherein decoding at least the portion of the one of the plurality of previously stored audio stream packet payloads further comprises setting an intermediate buffer read pointer value to a stored address associated with at least the portion of the one of the plurality of previously stored audio stream packet payloads.

28. The method of claim 25, wherein prior to parsing the audio stream packet and storing at least the portion of the audio stream packet payload, the method comprises setting an intermediate buffer write pointer value to an intermediate buffer read pointer value.

29. An apparatus comprising a digital signal processor and at least one memory containing instructions that when executed by the digital signal processor cause the digital signal processor to:
determine whether a current intermediate buffer read pointer value was advanced across a payload boundary having timing information to provide a determination result, wherein each payload boundary represents a location in an intermediate buffer representing at least one of a last part of a first previously stored audio stream packet payload and a first part of a second previously stored audio stream packet payload;
when the determination result is not favorable, perform at least one of:
decoding at least a portion of the second previously stored audio stream packet payload; and
parsing an audio stream packet;
and
when the determination result is favorable, perform at least one of:
decoding one of: at least the portion of the second previously stored audio stream packet payload, and at least a portion of one of a plurality of third previously stored audio stream packet payloads; and
parsing the audio stream packet.

30. The apparatus of claim 29, wherein parsing the audio stream packet further comprises storing at least the portion of the audio stream packet payload in the intermediate buffer.

31. The apparatus of claim 29, wherein parsing the audio stream packet further comprises storing timing information associated with the audio stream packet if the timing information was contained within a header of the audio stream packet.

32. The apparatus of claim 29, wherein storing at least the portion of the audio stream packet payload in the intermediate buffer comprises storing at least the portion of the audio stream packet payload in the intermediate buffer at a location indicated by a current intermediate buffer write pointer value.

33. The apparatus of claim 29, wherein when the determination result is favorable:
decoding at least the portion of the second previously stored audio stream packet payload if at least the portion of the second previously stored audio stream packet payload is determined to be on time with respect to a system time clock based on the timing information; and
decoding at least the portion of the one of the plurality of previously stored audio stream packet payloads if at least the portion of the second previously stored audio stream packet payload is determined to be behind time with respect to the system time clock based on the timing information and if at least the portion of the one of the plurality of previously stored audio stream packet payloads is determined to be one of on time with respect to the system time clock based on timing information associated with the one of the plurality of previously stored audio stream packet payloads and ahead of time with respect to the system time clock based on timing information associated with the one of the plurality of previously stored audio stream packet payloads.

34. The apparatus of claim 33, wherein decoding at least the portion of the one of the plurality of previously stored audio stream packet payloads, the instructions further cause the digital signal processor to set the intermediate buffer read pointer value to a stored address associated with at least the portion of the one of the plurality of the previously stored audio stream packet payloads.

35. The apparatus of claim 25, wherein when the determination result is favorable, parsing the audio stream packet if at least the portion of the second previously stored audio stream packet payload is determined to be behind time with respect to the system time clock based on the timing information and if at least the portion of the one of the plurality of previously stored audio stream packet payloads is determined to be behind time with respect to the system time clock based on timing information associated with the one of the plurality of previously stored audio stream packet payloads and if a header of the audio stream packet contains timing information.

36. The apparatus of claim 25, wherein the timing information is a presentation time stamp.

37. The apparatus of claim 25, wherein the current audio stream packet is a packet of a packetized elementary stream.

38. An apparatus comprising a digital signal processor and at least one memory containing instructions that when executed by the digital signal processor cause the digital signal processor to:
determine that at least a portion of a first previously stored audio stream packet payload is behind time with respect to a system time clock;
determine if at least a portion of one of a plurality of previously stored audio stream packet payloads is one of: on time with respect to a system time clock and ahead of time with respect to a system time clock and producing a determination result;
if the determination result is favorable, decode at least the portion of the one of the plurality of previously stored audio stream packet payloads; and
if the determination result is not favorable, parse an audio stream packet and storing at least a portion of an audio stream packet payload in an intermediate buffer.

39. The apparatus of claim 38, wherein:
at least the portion of the first previously stored audio stream packet payload is determined to be behind time with respect to the system time clock based on timing information associated with the first previously stored audio stream packet payload; and
at least the portion of the one of the plurality of previously stored audio stream packet payloads is determined to be one of: on time with respect to the system time clock and ahead of time with respect to the system time clock based on timing information associated with the one of the plurality of previously stored audio stream packet payloads.

40. The apparatus of claim 38, wherein decoding at least the portion of the one of the plurality of previously stored audio stream packet payloads the instruction further comprising setting an intermediate buffer read pointer value to a stored address associated with at least the portion of the one of the plurality of previously stored audio stream packet payloads.

41. The apparatus of claim 38, wherein prior to parsing the audio stream packet and storing at least the portion of the audio stream packet payload, the instructions cause the digital signal processor to set an intermediate buffer write pointer value to an intermediate buffer read pointer value.
